(19) United States
(12) Patent Application Publication
(10) Pub. No.: US 2018/0032361 A1
(43) Pub. Date: Feb. 1, 2018

(54) Virtual Machines Deployment in a Cloud

(71) Applicant: HEWLETT PACKARD ENTERPRISE DEVELOPMENT LP, Houston, TX (US)

(72) Inventors: Siva Subramaniam Manickam, Bangalore (IN); Balaji Ramamoorthi, Bangalore (IN); Maheshkumar Pandurangan, Bangalore (IN)

(21) Appl. No.: 15/223,121

(22) Filed: Jul. 29, 2016

(51) Int. Cl. G06F 9/455

(52) U.S. Cl. CPC G06F 9/45558; G06F 2009/45595; G06F 2009/4557

(57) ABSTRACT

Examples described relate to deployment of virtual machines in a cloud. In an example, receipt of a request for deployment of a virtual machine in a cloud computing environment may be determined, wherein the cloud computing environment includes a plurality of hypervisors hosted on a plurality of racks. Based on a current usage of respective hypervisors of the plurality of hypervisors, a hypervisor that meets the requirement of the virtual machine may be identified, and the virtual machine may be deployed on the hypervisor.

### BACKGROUND

Information technology (IT) infrastructures of organizations have grown over the last few decades. The number of IT components under the management of an enterprise may range from a few units to thousands of components. In addition, technologies such as virtualization and cloud computing have led to the inclusion of new kinds of IT components (for example, virtual machines) to existing IT infrastructures.

### BRIEF DESCRIPTION OF THE DRAWINGS

For a better understanding of the solution, examples will now be described, purely by way of example, with reference to the accompanying drawings, in which:

FIG. 1 is a block diagram of an example computing environment for deploying virtual machines;

FIG. 2 is a block diagram of an example computing system for deploying virtual machines in a cloud;

FIG. 3 is a block diagram of an example computing system for deploying virtual machines in a cloud;

FIG. 4 is a flowchart of an example method of deploying virtual machines in a cloud; and

FIG. 5 is a block diagram of an example system including instructions in a machine-readable storage medium for deploying virtual machines in a cloud.

### DETAILED DESCRIPTION

Information technology (IT) infrastructure of organizations have grown in diversity and complexity over the years due to developments in technology. Enterprises are increasingly adopting cloud-based solutions for their IT requirements.

Generally speaking, cloud computing involves delivery of computing as a service rather than a product whereby shared resources (software, storage resources, etc.) may be provided to computing devices as a service. The resources may be shared over a network (for example, the internet). One of the reasons behind the success of cloud computing is a technology called virtualization. Virtualization allows creation of a virtual version of a resource such as an operating system, a hardware platform, a storage resource etc. which may be shared, for instance, among different clients. Multiple virtual machines (VMs) may be created on a host device (for example, a server).

An example cloud computing environment may include hundreds of servers, which may be arranged in a plurality of racks. A plurality of these servers may each include a hypervisor or virtual machine monitor (VMM) that may be used to create and run one or more virtual machines. There may be a scenario wherein a plurality of hypervisors may be unutilized (e.g., no virtual machines are hosted) or underutilized (e.g., very few virtual machines are hosted). However, these hypervisors may be powered on all the time in the cloud. This may lead to high operational costs due to power and cooling costs involved in maintaining these hypervisors. Further, scheduling mechanisms for the deployment of new virtual machines do not take into account power usage of the hypervisors in a cloud. They also do not consider the current usage of a powered on hypervisor (e.g., number of virtual machines hosted) prior to deployment of a new virtual machine. This may lead to a scenario wherein one or more hypervisors may be unutilized or underutilized but may still add to operational costs of a cloud. Needless to say, this is not a desirable scenario.

To address these technical challenges the present disclosure describes various examples for deploying virtual machines in a cloud. In an example, upon receipt of a request for the deployment of a virtual machine in a cloud computing environment, the request may be detected by a receipt engine of a scheduling service. The requirements of the virtual machine may be determined and, based on a current usage of respective hypervisors, a hypervisor that meets the requirement of the virtual machine may be identified. The virtual machine may then be hosted on the hypervisor that meets the requirement of the virtual machine.

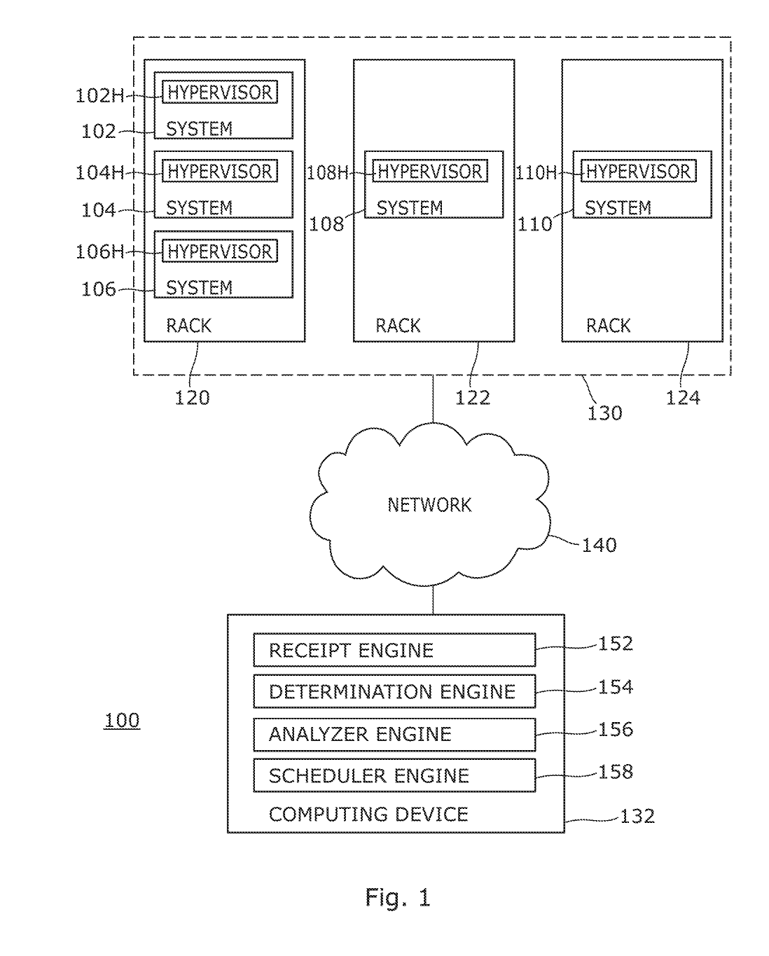

FIG. 1 is a block diagram of an example computing environment 100 for deploying virtual machines. In an example, computing environment 100 may include a computing infrastructure 130 and a computing device 132. The computing infrastructure 130 may include a plurality of computer systems 102, 104, 106, 108, and 110. The computer systems 102, 104, 106, 108, and 110 may be arranged in a plurality of racks 120, 122, and 124. In the example of FIG. 1, computer systems 102, 104, and 106 may be arranged in rack 120, computer system 108 may be arranged in rack 122, and computer system 110 may be arranged in rack 124. Although five computer systems and three racks are shown in FIG. 1, other examples of this disclosure may include more or less than five computer systems, and more or less than three racks.

In an example, computing infrastructure 130 may represent a cloud computing environment, and computer systems 102, 104, 106, 108, and 110 may represent cloud resources. Cloud computing environment 130 may represent a public cloud, a private cloud, or a hybrid cloud. Cloud computing environment 130 may be used to provide or deploy various types of cloud services. These may include Infrastructure as a Service (IaaS), Platform as a Service (PaaS), Software as a Service (SaaS), and so forth. In another example, computing infrastructure 130 may represent a data center.

In an example, computer systems 102, 104, 106, 108, and 110 may each be a computing device such as a computer server. Computer systems 102, 104, 106, 108, and 110, may be communicatively coupled, for example, via a computer network 140. Computer network 140 may be a wireless or wired network. Computer network may include, for example, a Local Area Network (LAN), a Wireless Local Area Network (WAN), a Metropolitan Area Network (MAN), a Storage Area Network (SAN), a Campus Area Network (CAN), or the like. Further, computer network 140 may be a public network (for example, the Internet) or a private network (for example, an intranet).

In an example, computing device 132 may represent any type of system capable of reading machine-executable instructions. Examples of the computing device 132 may include, without limitation, a server, a desktop computer, a notebook computer, a tablet computer, a thin client, a mobile device, a personal digital assistant (PDA), a phablet, and the like. Computing device 132 may be in communication with the computing infrastructure, for example, via a computer network. Such a computer network may be similar to the computer network 140 described above. In an example, computing device 132 may be a part of the computing infrastructure 130.

In an example, computer systems 102, 104, 106, 108, and 110 may each include a hypervisor (for example, 102H, 104H, 106H, 108H, and 110H, respectively). A hypervisor is a hardware virtualization layer that abstracts processor, memory, storage and network resources of a hardware platform and allows one or multiple operating systems (termed guest operating systems) to run concurrently on a host device. Virtualization allows the guest operating systems to run on isolated virtual environments (termed as virtual machines (VMs)). A computer system on which a hypervisor is running a virtual machine may be defined as a host machine. For instance, computer systems 102, 104, 106, 108, and 110 may each act as a host machine. Any number of virtual machines may be hosted on a hypervisor. In an example, hypervisors 102H, 104H, 106H, 108H, and 110H may each include a bare-metal hypervisor.

Referring to FIG. 1, a hypervisor on each of the computer systems may host one or multiple virtual machines. In an example, computer systems 102, 104, 106, 108, and 110 may each include a virtual machine (for example, 102M, 104M, 106M, 108M, and 110M, respectively). Virtual machines may be used for a variety tasks, for example, to run multiple operating systems at the same time, to test a new application on multiple platforms, etc.

In an example, computing device 132 may include a receipt engine 152, a determination engine 154, an analyzer engine 156, and a scheduler engine 158. Engines 152, 154, 156, and 158 may be any combination of hardware and programming to implement the functionalities of the engines described herein. In examples described herein, such combinations of hardware and programming may be implemented in a number of different ways. For example, the programming for the engines may be processor executable instructions stored on at least one non-transitory machine-readable storage medium and the hardware for the engines may include at least one processing resource to execute those instructions. In some examples, the hardware may also include other electronic circuitry to at least partially implement at least one engine of the computing device 132. In some examples, the at least one machine-readable storage medium may store instructions that, when executed by the at least one processing resource, at least partially implement some or all engines of the computing device. In such examples, the computing device 132 may include the at least one machine-readable storage medium storing the instructions and the at least one processing resource to execute the instructions.

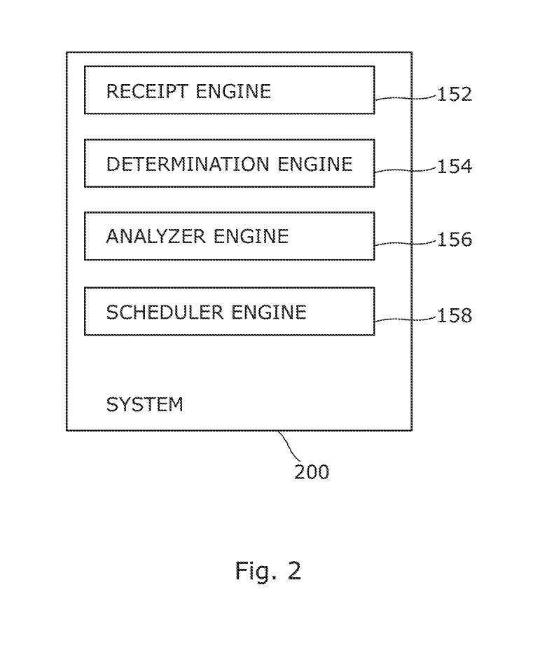

The functionalities performed by receipt engine 152, determination engine 154, analyzer engine 156, and scheduler engine 158 are described in reference to FIG. 2 below.

FIG. 2 is a block diagram of an example computing system 200 for deploying virtual machines in a cloud. In an example, computing system 200 may be analogous to the computing device 132 of FIG. 1, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

In an example, system 200 may represent any type of computing device capable of reading machine-executable instructions. Examples of computing device may include, without limitation, a server, a desktop computer, a notebook computer, a tablet computer, a thin client, a mobile device, a personal digital assistant (PDA), a phablet, and the like. In an example, system 200 may be communicatively coupled to a computing infrastructure (for example, 102) that may include a plurality of computer systems.

In an example, system 200 may include a receipt engine 152, a determination engine 154, an analyzer engine 156, and a scheduler engine 158.

Receipt engine 152 may determine receipt of a request for the deployment of a new virtual machine(s) in a computing infrastructure (for example, 102). The computing infrastructure may include a plurality of hypervisors hosted on a plurality of racks. In an example, the computing infrastructure may represent a cloud computing environment. In an example, the request may include a virtual machine installation request and a virtual machine initiation request. The virtual machine installation request may represent a request to install a virtual machine according to a specific set of configurations. The virtual machine initiation request may represent a request to commence the operations of the virtual machine.

The request may include information related to the requirements of the new virtual machine. In other words, the request may specify a set of parameters and/or configurations that may be specific to that request. These may include hardware and/or software requirements of the virtual machine.

In an example, a user may provide the request for the deployment of a new VM in a cloud computing environment. In another example, the request may be system-generated (for example, by a computer application). In either case, once the request is received by the cloud computing environment, receipt engine 152 may determine receipt of such request. Further to the determination, receipt engine 152 may communicate the request to determination engine 154.

Determination engine 154 may determine the requirements of the new virtual machine. These may include hardware and/or software requirements of the virtual machine. Some examples of the hardware and/or software requirements may include memory requirement, processing requirement, storage requirement, operating system requirement (for example, Linux), input and/or output requirements, and the like. In an example, determining the requirements of the new virtual machine may include receiving the request for the virtual machine and analyzing the requirements of the virtual machine from the received request. Further to the determination, determination engine 154 may communicate the requirements of the new virtual machine to analyzer engine 156.

Analyzer engine 156 may identify a hypervisor in the computing infrastructure that meets the requirements of the new virtual machine. In some implementations, analyzer engine 156 may identify the hypervisor based on an analysis of a current usage of respective hypervisors in the computing infrastructure. In an example, the current usage may include a power usage of the respective hypervisors. Analyzer engine 156 may determine a current state of power usage of the respective hypervisors. In an example, determining the current state of power usage may include determining for each of the respective hypervisors whether a hypervisor is in a powered on state or a powered off state. Based on the determination, analyzer engine 156 may identify a hypervisor(s) that may be present in a powered on state.

In another example, the current usage may include a number of virtual machines hosted by the respective hypervisors. Analyzer engine 156 may determine the number of virtual machines currently hosted on the respective hypervisors. Based on the determination, analyzer engine 156 may identify a hypervisor(s) that hosts the largest number of virtual machines. In an example, analyzer engine 156 may generate a list that sorts hypervisors based on the number of virtual machines hosted by them.

In another example, analyzer engine 156 may identify a rack in the computing infrastructure that hosts the largest number of virtual machines. Analyzer engine 156 may then determine whether a hypervisor on the rack is able to meet the requirements of the new virtual machine. For this determination, analyzer engine 156 may analyze a current usage of each hypervisor on the rack. In an example, determining the current usage may include determining for each hypervisor in the rack whether a hypervisor is in a powered on state or a powered off state. Based on the determination, analyzer engine 156 may identify a hypervisor(s) that may be present in a powered on state. In another example, determining the current usage may include determining a number of virtual machines hosted on each hypervisor of the rack. Based on the determination, analyzer engine 156 may identify a hypervisor that hosts the largest number of virtual machines on the rack. In a like manner, analyzer engine 156 may generate a list that sorts racks in the computing infrastructure based on the number of virtual machines hosted by them.

In an example, analyzer engine 156 may identify racks that are in powered on state in the computing infrastructure. Analyzer engine 156 may then determine, based on a current usage of respective hypervisors on the powered on racks, whether a hypervisor that meets the requirement of the virtual machine is available on a powered on rack. In an example, the current usage may include a number of virtual machines hosted by the respective hypervisors on the powered on racks.

Thus, based on a current usage, analyzer engine 156 may identify a hypervisor in the computing infrastructure that meets the requirements of the new virtual machine. Further to the determination, analyzer engine 156 may communicate the information related to the identified hypervisor to scheduler engine 158.

Scheduler engine 158 may deploy the new virtual machine on the hypervisor that meets the requirements of the virtual machine. In an example, scheduler engine 158 may deploy the new virtual machine on a hypervisor that is in a powered on state if the hypervisor is able to meet the requirements of the new virtual machine. Thus, scheduler engine 158 may avoid using a hypervisor that is in a powered off state. In other words, powering on of a powered off hypervisor may be avoided in order to host the new virtual machine. This may lead to savings in operational costs since less power may be used if an existing powered on hypervisor is used for hosting the new virtual machine rather than powering on a powered off hypervisor to host the new virtual machine.

In another example, scheduler engine 158 may deploy the new virtual machine on a hypervisor that hosts the largest number of virtual machines if the hypervisor is able to meet the requirements of the new virtual machine. In a further example, if the hypervisor that hosts the largest number of virtual machines is unable to meet the requirements of the new virtual machine, scheduler engine 158 may utilize the list that sorts hypervisors based on the number of virtual machines hosted by them to identify a hypervisor that may meet the requirements of the new virtual machine.

In a yet another example, scheduler engine 158 may deploy the new virtual machine on a hypervisor of the rack that hosts the largest number of virtual machines if the hypervisor is able to meet the requirements of the new virtual machine. If no hypervisor on the rack that hosts the largest number of virtual machines is able to meet the requirements of the new virtual machine, scheduler engine 158 may deploy the virtual machine on a hypervisor of a new rack in the computing infrastructure. The new rack may be powered on before the new virtual machine is deployed.

In another example, if no hypervisor on the rack that hosts the largest number of virtual machines is able to meet the requirements of the new virtual machine, scheduler engine 158 may utilize the list that sorts racks based on the number of virtual machines hosted by them. Scheduler engine 158 may scan the list of racks sorted in a decreasing order of the number of virtual machines hosted by them to identify a rack that includes a hypervisor that may meet the requirements of the new virtual machine. In case none of the racks in the computing infrastructure includes a hypervisor that is able to meet the requirements of the new virtual machine, scheduler engine 158 may deploy the virtual machine on a hypervisor of a new rack in the computing infrastructure. The new rack may be powered on before the new virtual machine is deployed.

In a further example, scheduler engine 158 may deploy the new virtual machine on a hypervisor of a powered on rack. In case, a hypervisor that meets the requirement of the new virtual machine is not available on a powered on rack, scheduler engine 158 may deploy the virtual machine on a hypervisor of a new rack in the computing infrastructure. The new rack may be powered on before the new virtual machine is deployed.

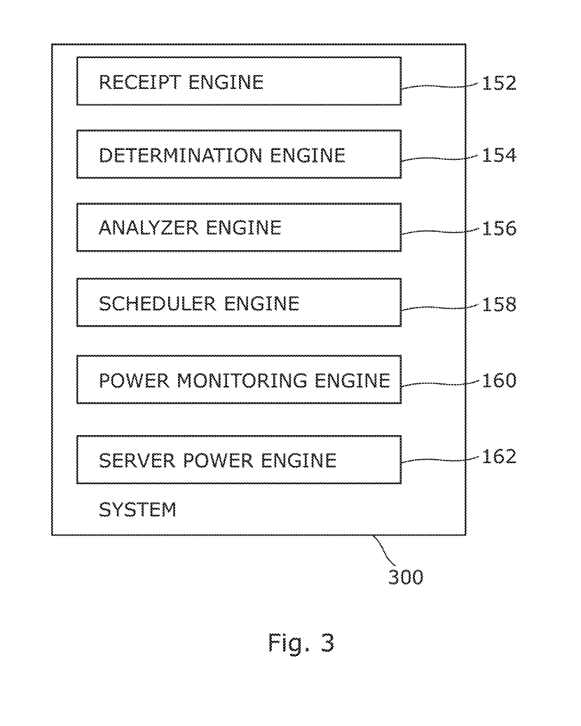

FIG. 3 is a block diagram of an example computing system 300 for deploying virtual machines in a cloud. In an example, computing system 300 may be analogous to the computing device 132 of FIG. 1 or system 200 of FIG. 2, in which like reference numerals correspond to the same or similar, though perhaps not identical, components. For the sake of brevity, components or reference numerals of FIG. 3 having a same or similarly described function in FIG. 1 or 2 are not being described in connection with FIG. 3. Said components or reference numerals may be considered alike.

In an example, system 300 may represent any type of computing device capable of reading machine-executable instructions. Examples of computing device may include, without limitation, a server, a desktop computer, a notebook computer, a tablet computer, a thin client, a mobile device, a personal digital assistant (PDA), a phablet, and the like. In an example, system 300 may be communicatively coupled to a computing infrastructure (for example, 102) that may include a plurality of computer systems.

In an example, system 300 may include a receipt engine 152, a determination engine 154, an analyzer engine 156, a scheduler engine 158, a power monitoring engine 160, and a server power engine 162.

Power monitoring engine 160 may monitor power usage information of a hypervisor(s) in a computing infrastructure (for example, 102). In an example, monitoring power usage information of a hypervisor may comprise determining a current state of power usage of a hypervisor and collecting power usage information of the hypervisor. In an example, determining the current state of power usage may include determining whether a hypervisor is in a powered on state or a powered off state. Power monitoring engine 160 may store power usage information of a hypervisor in a database. In an example, the stored information may be used by analyzer engine.

In another example, power monitoring engine 160 may monitor power usage information of a rack in a computing infrastructure (for example, 102). In an example, monitoring power usage information of a rack may comprise determining a current state of power usage of respective hypervisors in the rack and collecting power usage information of respective hypervisors. In an example, determining the current state of power usage may include determining whether respective hypervisors are in a powered on state or a powered off state. Power monitoring engine 160 may store power usage information of a rack in a database. In an example, the stored information may be used by analyzer engine.

Server power engine 162 may power on or power off a rack in a compute infrastructure (for example, 102). In an example, server power engine 162 may power on a new rack in a compute infrastructure in response to the determination by analyzer engine that no hypervisor on the rack that hosts the largest number of virtual machines is able to meet the requirement of a new virtual machine. In another example, server power engine 162 may power on a new rack in a compute infrastructure in response to the determination by analyzer engine that no hypervisor is available on powered on racks of a compute infrastructure that meets the requirement of a new virtual machine.

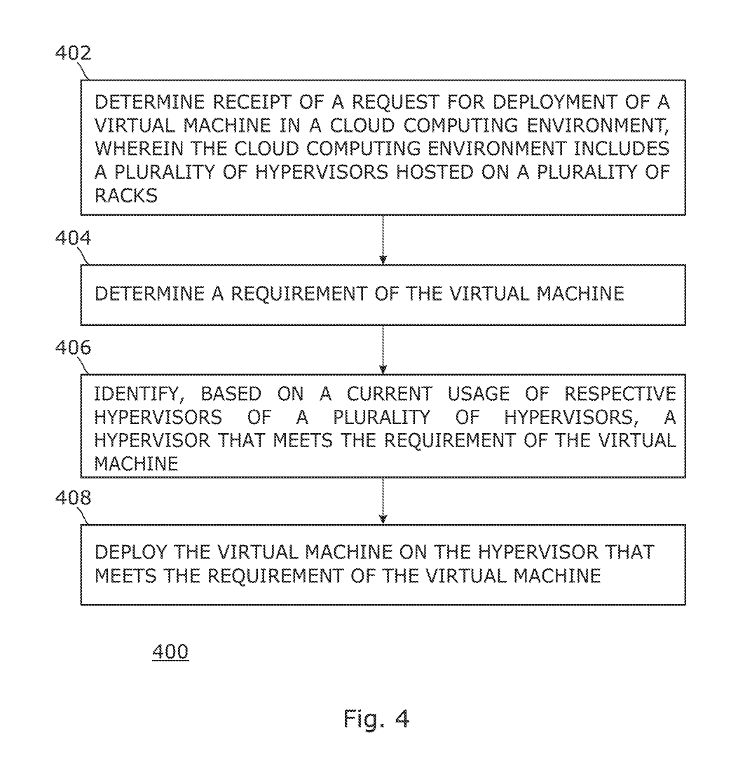

FIG. 4 is a flowchart of an example method 400 of deploying virtual machines in a cloud. The method 400, which is described below, may be executed on a computing device such as computing device 132 of FIG. 1 or systems 200 and 300 of FIGS. 2 and 3, respectively. However, other computing devices may be used as well. At block 402, method 400 may include determining receipt of a request for deployment of a virtual machine in a cloud computing environment. The cloud computing environment may include a plurality of hypervisors hosted on a plurality of racks. At block 404, method 400 may include determining a requirement of the virtual machine. At block 406, method 400 may include identifying, based on a current usage of respective hypervisors, a hypervisor that meets the requirement of the virtual machine. At block 408, method 400 may include deploying the virtual machine on the hypervisor that meets the requirement of the virtual machine.

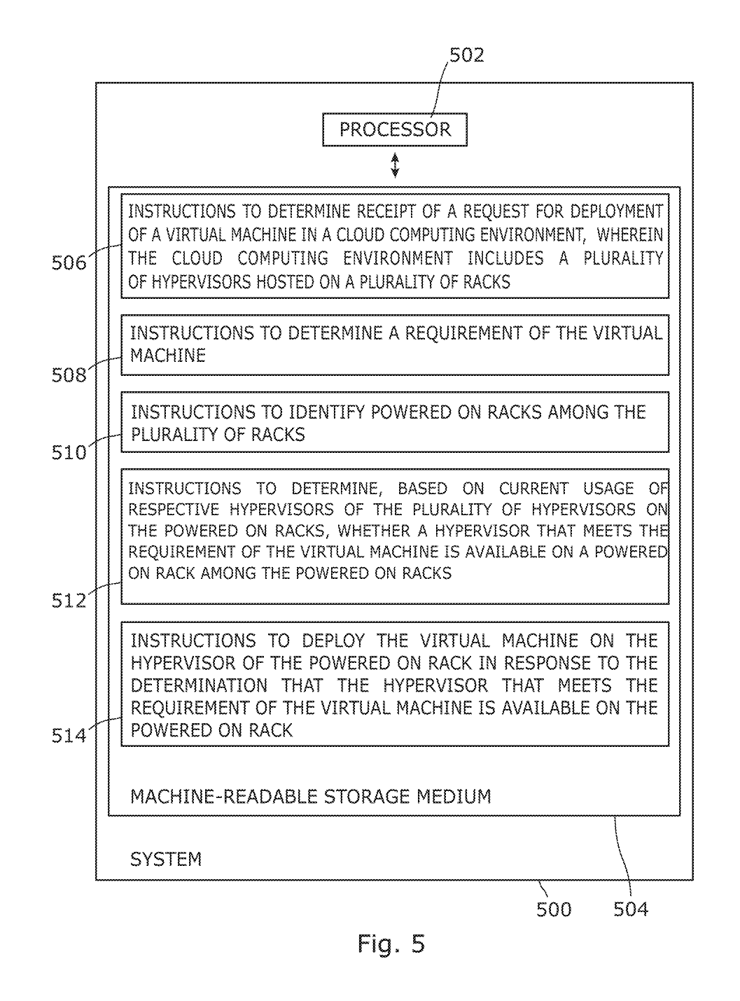

FIG. 5 is a block diagram of an example system 500 including instructions in a machine-readable storage medium for deploying virtual machines in a cloud. System 500 includes a processor 502 and a machine-readable storage medium 504 communicatively coupled through a system bus. In some examples, system 500 may be analogous to a computing device 132 of FIG. 1 or systems 200 and 300 of FIGS. 2 and 3, respectively. Processor 502 may be any type of Central Processing Unit (CPU), microprocessor, or processing logic that interprets and executes machine-readable instructions stored in machine-readable storage medium 504. Machine-readable storage medium 504 may be a random access memory (RAM) or another type of dynamic storage device that may store information and machine-readable instructions that may be executed by processor 502. For example, machine-readable storage medium 504 may be Synchronous DRAM (SDRAM), Double Data Rate (DDR), Rambus DRAM (RDRAM), Rambus RAM, etc. or storage memory media such as a floppy disk, a hard disk, a CD-ROM, a DVD, a pen drive, and the like. In an example, machine-readable storage medium may be a non-transitory machine-readable medium. Machine-readable storage medium 504 may store instructions 506, 508, 510, 512, and 514. In an example, instructions 506 may be executed by processor 502 to determine receipt of a request for deployment of a virtual machine in a cloud computing environment, wherein the cloud computing environment includes a plurality of hypervisors hosted on a plurality of racks. Instructions 508 may be executed by processor 502 to determine a requirement of the virtual machine. Instructions 510 may be executed by processor 502 to identify powered on racks among the plurality of racks. Instructions 512 may be executed by processor 502 to determine, based on a current usage of respective hypervisors on the powered on racks, whether a hypervisor that meets the requirement of the virtual machine is available on a powered on rack among the powered on racks. Instructions 514 may be executed by processor 502 to deploy the virtual machine on the hypervisor of the powered on rack in response to the determination that the hypervisor that meets the requirement of the virtual machine is available on the powered on rack.

For the purpose of simplicity of explanation, the example method of FIG. 4 is shown as executing serially, however it is to be understood and appreciated that the present and other examples are not limited by the illustrated order. The example systems of FIGS. 1, 2, 3 and 5, and method of FIG. 4 may be implemented in the form of a computer program product including computer-executable instructions, such as program code, which may be run on any suitable computing device in conjunction with a suitable operating system (for example, Microsoft Windows, Linux, UNIX, and the like). Examples within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It should be noted that the above-described examples of the present solution is for the purpose of illustration. Although the solution has been described in conjunction with a specific example thereof, numerous modifications may be possible without materially departing from the teachings of the subject matter described herein. Other substitutions, modifications and changes may be made without departing from the spirit of the present solution.

1. A method of deploying virtual machines in a cloud, comprising:
determining receipt of a request for deployment of a virtual machine in a cloud computing environment, wherein the cloud computing environment includes a plurality of hypervisors hosted on a plurality of racks;
determining a requirement of the virtual machine;
identifying, based on a current usage of respective hypervisors of the plurality of hypervisors, a hypervisor that meets the requirement of the virtual machine; and
deploying the virtual machine on the hypervisor that meets the requirement of the virtual machine.

2. The method of claim 1, wherein the current usage of the respective hypervisors includes a power usage of the respective hypervisors.

3. The method of claim 2, further comprising collecting information related to the power usage of the respective hypervisors.

4. The method of claim 3, wherein the collecting comprises collecting information related to a powered on state of the respective hypervisors.

5. The method of claim 1, wherein the current usage of the respective hypervisors includes a number of virtual machines hosted by the respective hypervisors.

6. The method of claim 1, further comprising:
determining whether a virtual machine is deployed on a rack among the plurality of racks other than a rack that includes the hypervisor that meets the requirement of the virtual machine; and
in response to the determination that no virtual machine is deployed on the rack among the plurality of racks other than the rack that includes the hypervisor that meets the requirement of the virtual machine, powering off all racks in the cloud computing environment other than the rack that includes the hypervisor that meets the requirement of the virtual machine.

7. A system for deploying virtual machines in a cloud, comprising:
a receipt engine to determine receipt of a request for deployment of a new virtual machine in a cloud computing environment, wherein the cloud computing environment includes a plurality of hypervisors hosted on a plurality of racks;
a determination engine to determine a requirement of the new virtual machine;
an analyzer engine to:
identify a rack among the plurality of racks that hosts a largest number of virtual machines; and
determine whether a hypervisor on the rack that hosts the largest number of virtual machines is able to meet the requirement of the new virtual machine; and
a scheduler engine to deploy the new virtual machine on the hypervisor in response to the determination that the hypervisor on the rack that hosts the largest number of virtual machines is able to meet the requirement of the new virtual machine.

8. The system of claim 7, further comprising a server power engine to power on a new rack among the plurality of racks in response to the determination that the hypervisor on the rack that hosts the largest number of virtual machines is not able to meet the requirement of the new virtual machine.

9. The system of claim 8, wherein the scheduler engine to deploy the new virtual machine on a hypervisor of the new rack.

10. The system of claim 7, wherein the scheduler engine to deploy the new virtual machine on a hypervisor of another rack of the plurality of racks in response to the determination that the hypervisor on the rack that hosts the largest number of virtual machines is unable to meet the requirement of the new virtual machine.

11. The system of claim 7, further comprising:
a power monitoring engine to collect power usage information of the respective hypervisors of the plurality of hypervisors.

12. The system of claim 11, wherein the power usage information includes information related to a powered on state of the respective hypervisors of the plurality of hypervisors.

13. The system of claim 7, wherein the hypervisor includes a bare-metal hypervisor.

14. A non-transitory machine-readable storage medium comprising instructions for deploying virtual machines in a cloud, the instructions executable by a processor to:
determine receipt of a request for deployment of a virtual machine in a cloud computing environment, wherein the cloud computing environment includes a plurality of hypervisors hosted on a plurality of racks;
determine a requirement of the virtual machine;
identify powered on racks among the plurality of racks;
determine, based on a current usage of respective hypervisors of the plurality of hypervisors on the powered on racks, whether a hypervisor that meets the requirement of the virtual machine is available on a powered on rack among the powered on racks; and
in response to the determination that the hypervisor that meets the requirement of the virtual machine is available on the powered on rack, deploy the virtual machine on the hypervisor of the powered on rack.

15. The storage medium of claim 14, further comprising instructions to power on a new rack among the plurality of racks in response to the determination that the hypervisor that meets the requirement of the virtual machine is not available on the powered on rack among the powered on racks.

16. The storage medium of claim 15, further comprising instructions to deploy the virtual machine on a hypervisor of the new rack.

17. The storage medium of claim 14, further comprising instructions to store information related to the hypervisor that meets the requirement of the virtual machine in a database.

18. The storage medium of claim 14, further comprising instructions to store power usage information related to the powered on racks in a database.

19. The storage medium of claim 14, wherein the current usage of the respective hypervisors includes a number of virtual machines hosted by the respective hypervisors on the powered on racks.

20. The storage medium of claim 14, wherein the requirement of the virtual machine includes at least one: a software component and a hardware component for hosting the virtual machine.
